(19) United States
(12) Patent Application Publication
(10) Pub. No.: US 2016/0334734 A1
(43) Pub. Date: Nov. 17, 2016

(54) IMAGE FORMING DEVICE

(71) Applicants: Satoshi KANEKO, Kanagawa (JP); Shinji KATO, Kanagawa (JP); Shuji HIRAI, Tokyo (JP)

(72) Inventors: Satoshi KANEKO, Kanagawa (JP); Shinji KATO, Kanagawa (JP); Shuji HIRAI, Tokyo (JP)

(21) Appl. No.: 15/221,003

(22) Filed: Jul. 27, 2016

Related U.S. Application Data
(63) Continuation of application No. PCT/JP2014/083098, filed on Dec. 15, 2014.

(30) Foreign Application Priority Data
Jan. 29, 2014 (JP) 2014-014740
Mar. 14, 2014 (JP) 2014-051187
Oct. 8, 2014 (JP) 2014-206886

(51) Int. Cl. G03G 15/08

(52) U.S. Cl. CPC G03G 15/0824

(57) ABSTRACT

A toner adhesion amount information detection unit detects toner adhesion amount information. An image density unevenness detection unit detects image density unevenness in an image. A toner image forming unit forms a latent image on the surface of the latent image bearer, and performs the developing processing by applying developing bias between the latent image bearer and a developer bearer. The toner adhesion amount information detection unit detects, as the toner adhesion amount information, developing current flowing between the developer bearer and the latent image bearer. The image density unevenness detection unit obtains, from the image information, an index value indicating a toner adhesion amount of a toner image portion when the developing current is detected, and detects the image density unevenness based on the image information and the developing current when the index value indicates a toner adhesion amount of a prescribed amount or more.

### CROSS-REFERENCE TO RELATED APPLICATIONS

The present application is a continuation application of International Application No. PCT/JP2014/083098, filed Dec. 15, 2014, which claims priority to Japanese Patent Applications No. 2014-014740, filed Jan. 29, 2014, No. 2014-051187, filed on Mar. 14, 2014, and No. 2014-206886, filed on Oct. 8, 2014. The contents of these applications are incorporated herein by reference in their entirety.

### BACKGROUND OF THE INVENTION

1. Field of the Invention

The present invention relates to an image forming device such as a printer, a copy machine, and a facsimile machine.

2. Description of the Related Art

In an electrographic image forming device, a photoconductor (latent image bearer) is uniformly charged by a charging unit, a latent image is formed by exposing a surface of the photoconductor by an exposure device (latent image forming unit) based on received image information, and developing is performed by making toner adhere to the latent image by a developing device (developing unit). As an image forming device described above, image forming devices disclosed in Japanese Patent No. 3825184, Japanese Patent No. 3224593, and Japanese Patent No. 4793340 are known.

Japanese Patent No. 3825184 discloses an image forming device in which a rectangular pattern (toner pattern for detecting image density unevenness) having a length corresponding to five rounds of a developing roller is formed on a photoconductor, and average image density unevenness per rotation cycle of the developing roller is calculated from a density detection result of the rectangular pattern. According to this image forming device, the calculated average density unevenness is used as a profile for correcting density unevenness, and developing bias is varied such that density of a toner image is decreased when the density of the toner image on the photoconductor is high, and in contrast, the density of the toner image is increased when the density of the toner image on the photoconductor is low. Consequently, the image density unevenness generated by the rotation cycle of the developing roller can be reduced.

Furthermore, Japanese Patent No. 3224593 and Japanese Patent No. 4793340 disclose an image forming device in which developing current flowing while developing a toner pattern for detecting image density unevenness is detected, and density unevenness of a toner pattern is grasped from time variation of the detected developing current. According to the image forming device, unevenness of a toner adhesion amount generated in the toner pattern, namely, the image density unevenness can be grasped from time variation of the developing current detected in a current detection circuit by utilizing an ideal correlation between a toner amount adhering to the toner pattern and a developing current amount.

Recently, an electrographic image forming device is started to be widely used in a print industry, and demands for high-speed output and high image quality are rapidly increased. Especially, regarding the high image quality, having uniform density within a page is strongly demanded. Image density unevenness within a page in a latent image bearer surface moving direction (sub-scanning direction) is caused by various factors such as charging unevenness due to ununiform charging, exposure unevenness of an exposure device, rotational deflection and sensitivity unevenness of a photoconductor, resistance unevenness of a developing roller (developer bearer), charging unevenness of toner, and transfer unevenness by a transfer unit.

For example, in the image forming device using electrophotography, developing is performed by making toner adhere to a latent image portion of the photoconductor by utilizing a developing field generated by a potential difference between a developing roller surface and the latent image portion on a photoconductor surface. At this point, when rotational deflection of the photoconductor or the developing roller is caused, a developing gap is varied and the developing field is varied. As a result, image density unevenness is generated by a rotation cycle of the photoconductor or the developing roller. Additionally, for example, in the case where the photoconductor has sensitivity unevenness, a difference is caused in potential of the photoconductor (potential of the latent image portion) after exposure even though exposure is performed with a constant exposure light amount. Therefore, the developing field is varied by the rotation cycle of the photoconductor and image density unevenness is generated. Thus, since the image density unevenness caused by the rotation cycle of the photoconductor and the developing roller is cyclically generated in a page, a user easily visually recognizes the same, and there is serious impact on the image density unevenness. Moreover, for example, in the case where there is resistance unevenness in the developing roller, the developing field is varied by the rotation cycle of the developing roller and image density unevenness is generated even when there is no developing gap. Thus, since the image density unevenness caused by the rotation cycle of the photoconductor and the developing roller is cyclically generated in a page, a user easily visually recognizes the same, and there is serious impact on the image density unevenness.

Among the image density unevenness generated in the sub-scanning direction in actual image forming, there are not only regular image density unevenness generated in every image forming but also image density unevenness generated unexpectedly or irregularly (hereinafter also referred to as “irregular image density unevenness”). In all of image forming devices in the related arts, a toner pattern for detecting image density unevenness is formed apart from image forming operation and image density unevenness of the toner pattern is detected, and then the image density unevenness generated in subsequent image forming operation is suppressed. According to such an image forming device, regular image density unevenness can be suppressed because image density unevenness thereof appears on the toner pattern. However, irregular image density unevenness does not constantly appear on the toner pattern and cannot be suppressed by the image forming device in the related arts.

Even when such irregular image density unevenness cannot be suppressed, if at least possible to detect generation thereof, a deteriorated image having the irregular image density unevenness can be specified from among images obtained by image forming. Consequently, work such as forming the same image again and replacing the deteriorated image with a normal image can be easily performed, and a situation such as using the deteriorated image having the irregular image density unevenness as it is can be prevented from occurrence. However, according to the method in the related arts in which the toner pattern for detecting image density unevenness is formed to detect the image density unevenness, not only the irregular image density unevenness cannot be suppressed but also generation thereof cannot be detected. Therefore, in order to replace the deteriorated image having the irregular image density unevenness with the normal image, the user himself/herself needs to visually confirm whether there is any image having the irregular image density unevenness in the formed image, and this confirmation work causes a burden to the user.

### SUMMARY OF THE INVENTION

According to one aspect of the present invention, an image forming device forms a toner image with a toner image forming unit based on image information on a surface of a latent image bearer whose surface moves, and finally transfers the formed toner image to a recording material so as to form an image on the recording material. The image forming device includes a toner adhesion amount information detection unit and an image density unevenness detection unit. The toner adhesion amount information detection unit detects toner adhesion amount information indicating a toner adhesion amount of a toner image formed based on image information. The image density unevenness detection unit detects, based on the image information and the toner adhesion amount information detected by the toner adhesion amount information detection unit, image density unevenness in an image formed based on the image information. The toner image forming unit forms a latent image based on the image information on the surface of the latent image bearer, and performs the developing processing in which toner charged to a predetermined polarity by applying developing bias between the latent image bearer and a developer bearer is moved from the developer bearer to the latent image, so as to form the toner image on the surface of the latent image bearer. The toner adhesion amount information detection unit is a developing current detection unit configured to detect, as the toner adhesion amount information, developing current flowing between the developer bearer and the latent image bearer at a time of performing developing processing for the latent image formed based on image information. The image density unevenness detection unit obtains, from the image information, an index value indicating a toner adhesion amount of a toner image portion existing between the developer bearer and the latent image bearer when the developing current detection unit detects developing current, and detects the image density unevenness based on the image information and the developing current flowing in the toner image portion when the index value indicates a toner adhesion amount of a prescribed amount or more.

### BRIEF DESCRIPTION OF THE DRAWINGS

FIG. 1 is a schematic structural diagram illustrating an image forming device according to a first embodiment;

FIG. 2 is a schematic structural diagram illustrating an image forming unit in the same image forming device;

FIG. 3 is a schematic structural diagram illustrating a developing device in the same image forming device;

FIG. 4 is an explanatory diagram for a main control system in the same image forming device;

FIG. 5A is a diagram schematically illustrating a picture image of exemplary received image data;

FIG. 5B is a graph illustrating a dot count integral value in each segment in a sub-scanning direction of the same image illustrated in FIG. 5A;

FIG. 5C is a graph illustrating time variation of developing current detected relative to the same image illustrated in FIG. 5A (developing current value in each position in the sub-scanning direction);

FIG. 6 is a flowchart illustrating a flow of controlling detection of image density unevenness according to the first embodiment;

FIG. 7 is a diagram illustrating an exemplary display content displayed on a display unit of the same image forming device;

FIG. 8 is a diagram illustrating another exemplary display content displayed on the display unit of the same image forming device;

FIG. 9 is a schematic structural diagram illustrating a developing device and a toner amount adjustment device in an image forming device according to a second embodiment;

FIG. 10 is an explanatory diagram for a main control system in the same image forming device;

FIG. 11 is a flowchart illustrating a flow of controlling detection of image density unevenness according to the second embodiment;

FIG. 12 is a diagram illustrating another example of the same toner amount adjustment device;

FIG. 13A is a diagram schematically illustrating a picture image of exemplary received image data;

FIG. 13B is a graph illustrating a dot count integral value in each segment in a sub-scanning direction of the same image illustrated in FIG. 13A according to a second modified example;

FIG. 13C is a graph illustrating time variation of developing current detected relative to the same image illustrated in FIG. 13A (developing current value in each position in the sub-scanning direction) according to the second modified example;

FIG. 14A is a diagram schematically illustrating a picture image on a surface of an intermediate transfer belt relative to exemplary received image data; and

FIG. 14B is a graph illustrating a dot count integral value in each segment in the sub-scanning direction of the same image illustrated in FIG. 14A according to a third modified example.

The accompanying drawings are intended to depict exemplary embodiments of the present invention and should not be interpreted to limit the scope thereof. Identical or similar reference numerals designate identical or similar components throughout the various drawings.

### DETAILED DESCRIPTION OF THE PREFERRED EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

An embodiment of the present invention will be described in detail below with reference to the drawings.

An object of an embodiment is to provide an image forming device capable of detecting whether any irregular image density unevenness is generated in a formed image.

### First Embodiment

In the following, an embodiment of an image forming device according to the present invention will be described with reference to the drawings (hereinafter, the present embodiment will be referred to as “first embodiment”).

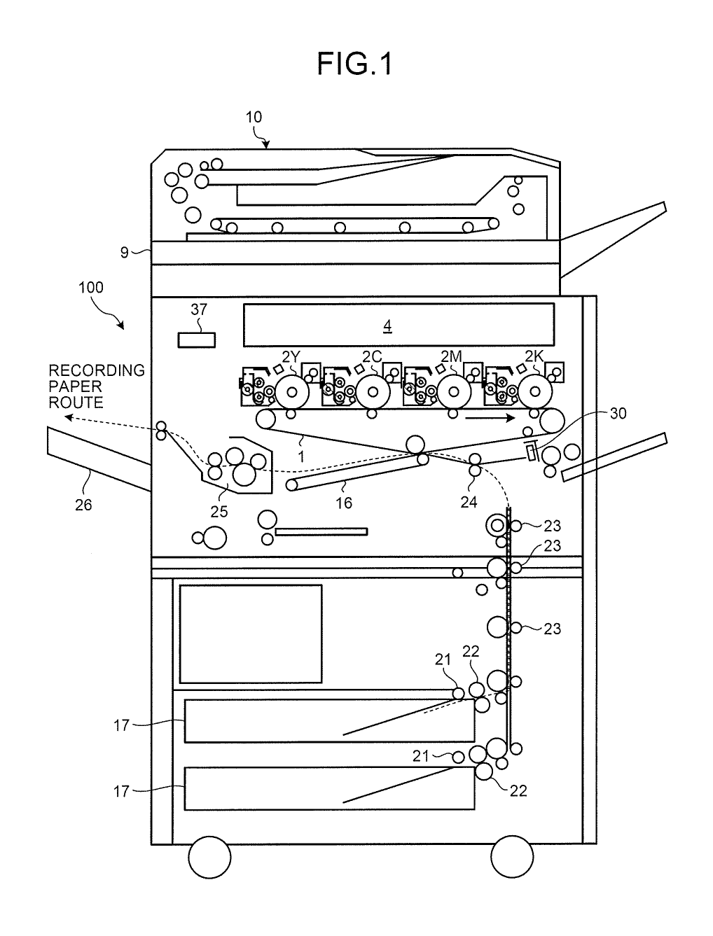

FIG. 1 is a schematic structural diagram illustrating an image forming device according to the first embodiment.

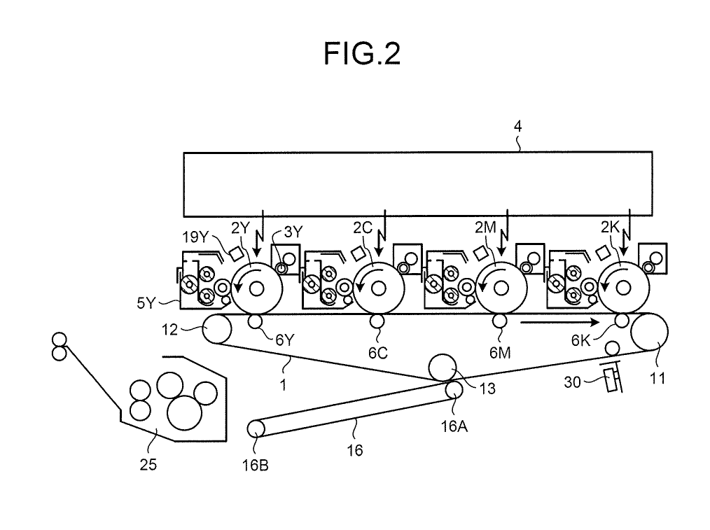

FIG. 2 is a schematic structural diagram illustrating an image forming unit in the same image forming device according to the first embodiment.

The image forming device illustrated in FIG. 1 is an example of a full-color machine of a quadruple tandem type intermediate transfer system, but the present invention is also applicable to an image forming devices having a different configuration, for example, a full-color machine of a quadruple tandem type direct transfer system, a full-color machine of one-drum type intermediate transfer system, a monochrome machine of one-drum type direct transfer system, and the like.

An image forming device 100 according to the first embodiment includes an intermediate transfer belt 1 that is an intermediate transfer body, and photoconductor drums 2Y, 2M, 2C, 2K that are latent image bearers arranged in parallel along an extended tense surface or a stretched tense surface of the intermediate transfer belt 1. Reference signs Y, M, C, K respectively represent colors of yellow, magenta, cyan, black.

Describing, as a representative, a yellow image formation station, a charging device including a charging roller 3Y, an optical writing unit 4 as a latent image forming unit to write an electrostatic latent image by performing exposure for the photoconductor drum 2Y, a surface potential sensor 19Y as a potential detection unit to detect surface potential of the photoconductor drum 2Y, a developing device 5Y, and the like are sequentially arranged around the photoconductor drum 2Y in a surface moving direction thereof. A toner image forming unit to form a toner image on the photoconductor drum 2Y includes the charging device 3Y, optical writing unit 4, developing device 5Y, and the like. Image formation stations of other colors have the same structure.

The intermediate transfer belt 1 is rotationally supported by rollers 11, 12, 13 as a plurality of supporting members. The intermediate transfer belt 1 is made of material prepared by dispersing, to polyimide resin having little elongation, carbon powder for adjusting electric resistance. A portion facing the roller 13 is provided with a secondary transfer belt 16 as a secondary transfer unit. The secondary transfer belt 16 is rotationally supported by two supporting rollers 16A, 16B.

The optical writing unit 4 emits writing light corresponding to the respective colors by driving four semiconductor lasers with a laser control unit not illustrated. Then, the photoconductor drums 2Y, 2C, 2M, 2K are scanned with the respective writing light in the dark, and electrostatic latent images for Y, M, C, K are written on surfaces of the respective photoconductor drums 2Y, 2C, 2M, 2K. In the first embodiment, as the optical writing unit, used is a component that polarizes the laser beam emitted from the semiconductor laser by a polygon mirror not illustrated while performing optical scanning by reflecting the laser light by a reflection mirror not illustrated and by passing the laser light through an optical lens. A component that performs optical writing by an LED array may also be used instead of the component having the above-described structure.

Above the optical writing unit 4, a scanner unit 9 as an image reading unit, an ADF 10 as an automatic document feeding unit, and the like are provided. At a lower portion of the image forming device 100, paper feeding trays 17 are provided as a plurality of paper feeding units. A recording paper stored in each of the paper feeding trays 17 as a recording material is fed by a pickup roller 21 and a feeding paper roller 22, conveyed by a conveying roller 23, and transmitted by a pair of registration rollers 24 at predetermined timing to a secondary transfer nip portion that is a secondary transfer area where the intermediate transfer belt 1 and the secondary transfer belt 16 face each other. A fixing unit 25 as a fixing unit is provided on a downstream side in a recording paper conveyance direction of the secondary transfer nip portion.

The surface potential sensors 19Y, 19C, 19M, 19K detect potential of electrostatic latent images written by the optical writing unit 4 on the photoconductor drums 2Y, 2M, 2C, 2K, namely, surface potential of the photoconductor drums 2Y, 2M, 2C, 2K before the toner is made to adhere and developed by the developing devices 5Y, 5C, 5M, 5K. The detected surface potential is fed back to setting information of image formation conditions, such as charging bias of the charging devices 3Y, 3C, 3M, 3K and laser power of the optical writing unit 4, and used to keep stability of image density.

In FIG. 1, reference sign 26 indicates a paper ejection tray, and reference sign 37 indicates a control section as a control unit mounted with a CPU, non-volatile memory, and volatile memory not illustrated.

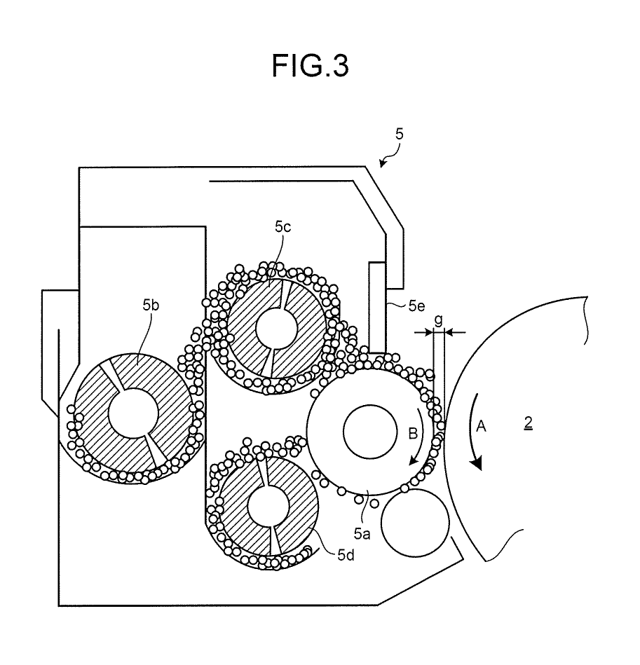

FIG. 3 is a schematic structural diagram illustrating the developing device according to the first embodiment. Meanwhile, in the following description, reference signs Y, C, M, K to differentiate the colors will be suitably omitted in a description common in the respective colors.

As illustrated in FIG. 3, the developing device 5 includes a developing roller 5a as a developer bearer arranged closed to a surface of the photoconductor drum 2 via a developing gap g. The developing roller 5a bears two-component developer including toner and a carrier (hereinafter simply referred to as “developer”) inside the developing device 5, and makes the toner contained inside the borne developer adhere to the photoconductor drum 2 in a developing area facing the photoconductor drum 2, and then perform developing processing to form a toner image on the photoconductor drum 2.

Inside a developer container of the developing device 5, a stirring screw 5b that is a developer stirring unit, a supply screw 5c, and a collection screw 5d are provided in parallel to the developing roller 5a. The stirring screw 5b conveys the developer to an end portion located in near-side direction of the drawing while stirring the developer, and conveys the same to the supply screw 5c through an opening portion not illustrated. The supply screw 5c conveys the developer along the developing roller 5a while stirring the same, and supplies the developer to a surface of the developing roller 5a. The developer supplied to the developing roller 5a is borne by the surface of the developing roller 5a due to action of a magnetic field by a magnetic field generation unit arranged inside the developing roller 5a, and conveyed with rotation of the developing roller 5a in a direction indicated by an arrow B in the drawing.

The developer borne by the surface of the developing roller 5a has a height thereof restricted by a doctor blade 5e as a developer restriction member, and then is conveyed to the developing area facing the surface of the photoconductor drum 2 that is being rotated in a direction indicated by an arrow A in the drawing. Then, the developing field is formed between the surface of the developing roller 5a and an electrostatic latent image on the photoconductor drum 2 due to action of the developing bias applied to the developing area by developing voltage supplied to the developing roller 5a from a power circuit 33, and the developing processing is performed by the toner adhering to the electrostatic latent image portion due to action of the developing field. When the toner is consumed by the developing processing and toner concentration of the developer contained in the developer container of the developing device 5 is decreased, the toner is supplied into the developer container from a toner supply unit not illustrated via an opening portion not illustrated located above the stirring screw 5b.

Meanwhile, in the first embodiment, a single-step forward developing system in which one developing roller is rotated in the direction same as the photoconductor drum in the developing area is used. However, not limited to this system, for example, a multiple developing system using a plurality of developing rollers or a reverse developing system in which a developing roller is rotated in a direction reverse to the photoconductor drum in the developing area may also be used. Furthermore, the first embodiment is an example of the two-component development, but one-component development not including a carrier may also be used.

The optical writing unit 4 drives the four semiconductor lasers not illustrated by the laser control unit not illustrated based on image information, and emits the writing light to each of the surfaces of the photoconductor drums 2Y, 2M, 2C, 2K uniformly charged by the charging devices 3Y, 3C, 3M, 3K in the dark. The optical writing unit 4 scans each of the photoconductor drums 2Y, 2M, 2C, 2K with the writing light in the dark, and writes the electrostatic latent images for Y, C, M, K on the surfaces of the photoconductor drums 2Y, 2M, 2C, 2K. In the first embodiment, as the optical writing unit 4, used is the component that polarizes the laser beam emitted from the semiconductor laser not illustrated by a polygon mirror not illustrated while performing optical scanning by reflecting the laser light by a reflection mirror not illustrated and by passing the laser light through an optical lens. As the optical writing unit 4, a component that writes an electrostatic latent image by an LED array may also be used instead of the component having the above-described structure.

Next, general image forming operation in the structure illustrated in FIG. 1 will be described.

When a print start command is received, rotation of respective rollers located around the photoconductor drums 2Y, 2M, 2C, 2K, around the intermediate transfer belt 1, on a recording paper conveyance route, and the like is started at predetermined timing, and feeding of recording papers is started from the paper feeding tray 17. On the other hand, the surfaces of the respective photoconductor drums 2Y, 2M, 2C, 2K are charged by the charging devices 3Y, 3M, 3C, 3K to have uniform potential, and the surfaces are exposed in accordance with image data corresponding to the respective colors by the writing light emitted from the optical writing unit 4, and then potential patterns subjected to exposure become the electrostatic latent image. The surfaces of the photoconductor drums 2Y, 2M, 2C, 2K bearing the electrostatic latent images are supplied with toner from the developing rollers 5a of the developing devices 5Y, 5M, 5C, 5K, thereby developing the electrostatic latent images borne by the photoconductor drums 2Y, 2M, 2C, 2K.

In the structure of FIG. 1, since the photoconductor drums 2Y, 2M, 2C, 2K for four colors are provided, respective toner images of yellow, magenta, cyan, black (color order is varied by each system) are developed on the respective photoconductor drums 2Y, 2M, 2C, 2K. The toner images developed on the respective photoconductor drums 2Y, 2M, 2C, 2K are transferred onto the intermediate transfer belt 1 by primary transfer bias and pressing force applied to primary transfer rollers 6Y, 6M, 6C, 6K arranged in a manner facing the photoconductor drums 2Y, 2M, 2C, 2K in a primary transfer nip portion as a primary transfer area that is a facing area between the photoconductor drums 2Y, 2M, 2C, 2K and the intermediate transfer belt 1. Such primary transfer operation is repeatedly performed for the four colors in synchronized timing, thereby forming a full-color toner image on the intermediate transfer belt 1.

The full-color toner image formed on the intermediate transfer belt 1 is transferred, in the secondary transfer nip portion, to a recording paper conveyed by the pair of registration rollers 24 in synchronized timing. At this point, secondary transfer is performed by secondary transfer bias and pressing force applied to the secondary transfer belt 16. The recording paper onto which the full-color toner image is transferred passes the fixing unit 25, thereby thermally fixing the toner image borne on the surface of the recording paper. After that, the recording paper is conveyed to the paper ejection tray 26.

The image forming device 100 includes a toner adhesion amount detection sensor 30 including an optical sensor to detect image density of a toner pattern formed on an outer peripheral surface of the intermediate transfer belt 1 (toner adhesion amount per unit area). The toner adhesion amount detection sensor 30 is used to detect image density of a predetermined toner pattern formed at the time of image quality adjustment control (process control), and a detection result thereof is fed back to the setting information of the image formation conditions such as the charging bias of the charging devices 3Y, 3C, 3M, 3K and the laser power of the optical writing unit 4, and used to keep stability of image density.

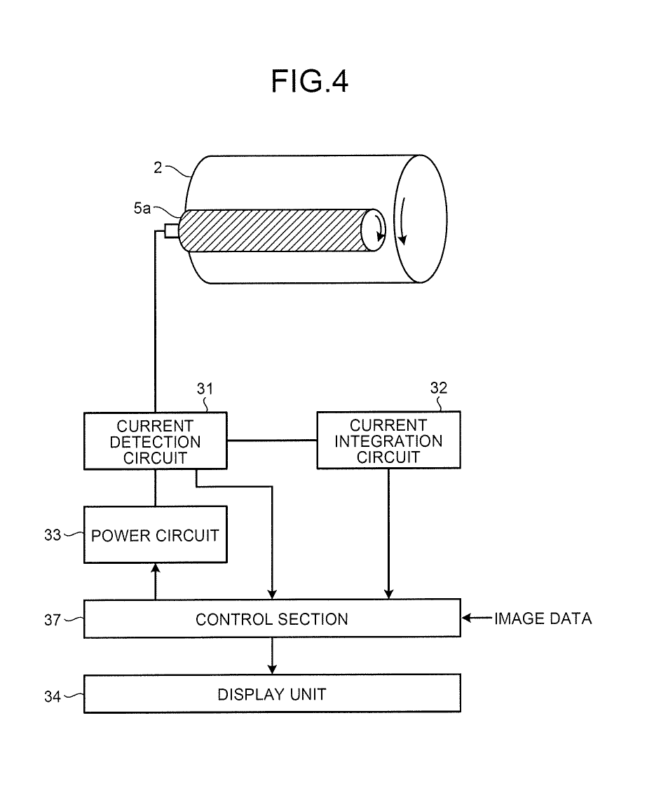

FIG. 4 is an explanatory diagram illustrating a main control system according to the first embodiment.

In the first embodiment, provided is a developing current detection unit as a toner adhesion amount information detection unit that detects, as toner adhesion amount information, developing current flowing between the photoconductor drum 2 of each of the colors and the developing roller 5a of the developing device 5. The developing current detection unit of the first embodiment including a current detection circuit 31 as illustrated in FIG. 4. The current detection circuit 31 is adapted to detect a current value output to the developing roller 5a from the power circuit 33 at the time of developing processing to develop an electrostatic latent image formed on the photoconductor drum 2 with the toner on the developing roller 5a based on the image data. The current output from the power circuit 33 to the developing roller 5a mostly flows to the photoconductor drum 2 by toner movement in the developing area. Therefore, the current value detected by the current detection circuit 31 corresponds to developing current flowing between the photoconductor drum 2 and the developing roller 5a at the time of developing processing.

In the first embodiment, the value of the developing current detected by the current detection circuit 31 is converted to a value (charge amount) integrated by a current integration circuit 32, and then the converted value is received in a control section 37. Alternatively, the value of the developing current detected by the current detection circuit 31 may also be directly received in the control section 37. Anyway, a voltage signal corresponding to the developing current value is received in the control section 37. The voltage signal may be a signal corresponding to an output signal directly output from the current detection circuit 31 or the current integration circuit 32, or a signal via a filter circuit having an appropriate cut-off frequency.

In the first embodiment, as described later, whether any image density unevenness exceeding an allowable range is generated in an image formed by the developing processing in which the developing current flows is determined in accordance with the developing current received in the control section 37. Then, in the case of determining that the image density unevenness is generated, such generation of the image density unevenness is informed to a user by using an informing unit like a display unit 34 such as an operation panel provided at the image forming device 100. At this point, preferably, only informing is performed without interrupting image forming operation. Furthermore, preferably, information that specifies in which image the image density unevenness is generated is also informed such that the user can easily specify in which image the image density unevenness is generated.

In actual image forming operation, not only regular image density unevenness generated in every image forming but also irregular image density unevenness may be generated. The regular image density unevenness can be improved by correcting the image formation conditions by feeding back detection results of the surface potential sensors 19Y, 19C, 19M, 19K, a detection result of the toner adhesion amount detection sensor 30 at the time of image quality adjustment (process control), and the like. However, the irregular image density unevenness cannot be improved by thus correcting the image formation conditions. Therefore, the user is obliged to visually confirm whether any irregular image density unevenness is generated in a formed image in every printing.

Accordingly, in the first embodiment, the control section 37 determines whether any image density unevenness is generated in each image actually formed, and in the case of determining that image density unevenness is generated, the fact is informed to the user, thereby reducing the burden of confirmation work performed by the user. Meanwhile, in the first embodiment, whether any image density unevenness is generated is determined from the detection result of the developing current, but not limited thereto. As far as a result is obtained by detecting the toner adhesion amount information indicating the toner adhesion amount of the toner image formed based on the image data, detection results of the surface potential sensors 19Y, 19C, 19M, 19K and a detection result of the toner adhesion amount detection sensor 30 can be also utilized.

However, content of the image actually formed is varied in accordance with the image data, and an entire image is not formed with constant image density like a toner pattern. Therefore, image density unevenness in a sub-scanning direction of the image cannot be directly grasped even though checking time variation of the developing current flowing while developing processing is performed for the actual image. On the other hand, the content of the image to be actually formed can be grasped from image data of this image, and a target value of image density variation (toner adhesion amount variation) in the sub-scanning direction of the image can be grasped from the image data. Therefore, in the first embodiment, from the developing current detected at the time of developing the actual image and the image data thereof, a deviation amount between a target toner adhesion amount and an actual toner adhesion amount of the image is grasped, and whether any image density unevenness is generated in the image is determined by checking variation of the deviation amount.

The image data received in the control section 37 is useful image information in order to grasp the target value of the toner adhesion amount of the toner image formed based on the image information such as information related to a formed image such as a printing rate in a main-scanning direction and image density, and writing information. In the first embodiment, the image data is divided into a plurality of segments in the sub-scanning direction, and the printing rate (area ratio of toner image portion) in each of the segments in the sub-scanning direction is grasped by using an integral value of a dot count value in the main-scanning direction in each of the segments (segments in the sub-scanning direction). Furthermore, information to grasp a relation between the detected developing current and a position on the image is also received in the control section 37. As an example of such information, information of writing start timing may be listed. Meanwhile, as far as the relation between the detected developing current and the position on the image can be grasped from the information, information at rising time of the detected developing current can also be used, not limited to the writing start timing.

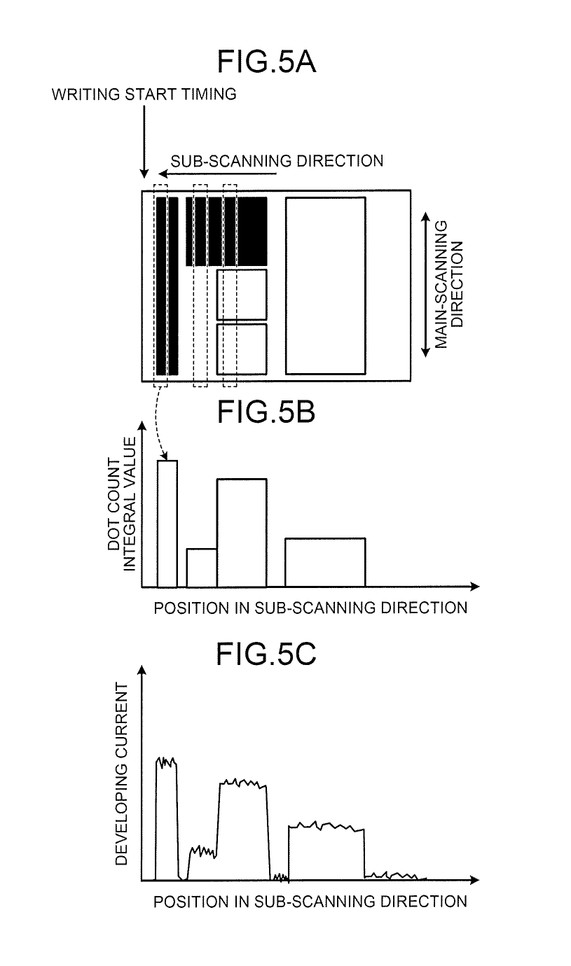

FIG. 5A is a diagram schematically illustrating a picture image of an exemplary received image data.

FIG. 5B is a graph illustrating a dot count integral value in each segment in the sub-scanning direction of the image illustrated in FIG. 5A.

FIG. 5C is a graph illustrating time variation of the detected developing current relative to the image illustrated in FIG. 5A (developing current value in each position in the sub-scanning direction).

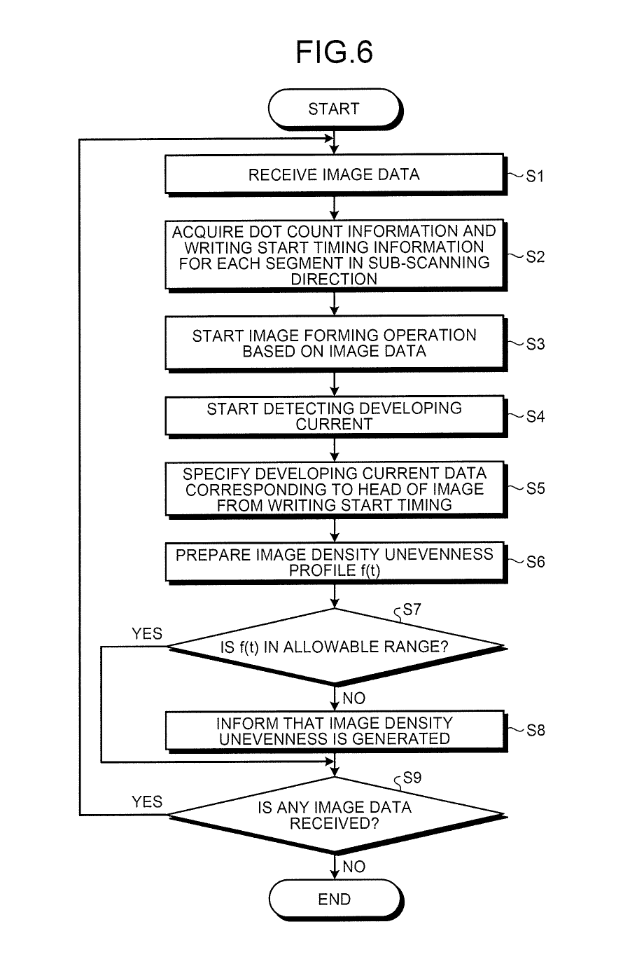

FIG. 6 is a flowchart illustrating a flow of controlling detection of image density unevenness according to the first embodiment.

In the case where the image data of the picture image as illustrated in FIG. 5A is received (S1), a controller not illustrated inside the image forming device 100 converts the received image data to a printer language, and writing information such as a dot count and writing start timing is obtained. The controller transmits the information of the writing start timing to the control section 37 together with the dot count information. The control section 37 acquires the image density information and a dot count value for each predetermined segment in the sub-scanning direction from the dot count information received from the controller (S2), and saves the same in a volatile memory.

In the first embodiment, the plurality of segments in the sub-scanning direction, which has a predetermined length in the sub-scanning direction, is set at a pitch of, for example, 10 mm in the sub-scanning direction (portions enclosed by dotted lines in FIG. 5A), and an integral value of the dot count in each of the segments in the sub-scanning direction is obtained. Meanwhile, as far as the toner adhesion amount in each of the segments in the sub-scanning direction can be estimated from the information, information other than the dot count integral value may also be used. Furthermore, in the case where a shorter pitch is required to be set, the pitch can be set shorter up to a pitch of about 1 mm in the sub-scanning direction in the first embodiment. The size of the pitch is suitably determined by a cycle of image density unevenness to be detected or the like. The pitch of the segments in the sub-scanning direction may be changed by control.

Furthermore, the dot count integral value is not necessarily obtained for an entire area in the sub-scanning direction of the image. For example, in the case of detecting image density unevenness having a relatively long cycle, the dot count integral value is needed to be obtained for the entire area in the sub-scanning direction of the image, but in the case of detecting image density unevenness having a relatively short cycle, the dot count integral value is not necessarily obtained for the entire area in the sub-scanning direction of the image when the area in the sub-scanning direction of the image is longer than the cycle. A range to obtain the dot count integral value (area in the sub-scanning direction of the image) can be easily set from an operation unit not illustrated or the like such as an operation panel.

When image forming operation is started based on the received image data (S3), the developing voltage is applied to the developing roller 5a from the power circuit 33 for developing, and at the same time, the control section 37 sequentially saves the developing current detected by the current detection circuit 31 in the volatile memory (S4). Furthermore, at the above-described writing start timing, forming of an electrostatic latent image is started based on the image data, and the formed electrostatic latent image passes the developing area with rotation of the photoconductor drum 2. The toner is supplied from above the developing roller 5a to the electrostatic latent image passing the developing area, and adheres to the image, and then the image is developed.

The control section 37 specifies developing current data corresponding to a head of the image from among the developing current data saved in the volatile memory from the writing start timing obtained from the controller (S5). Consequently, the value of each developing current corresponding to a position in the sub-scanning direction of the image data, namely, the developing current value in each of the above-described segments in the sub-scanning direction can be specified.

Next, the control section 37 calculates an image density unevenness profile f(t) of the image by Formula (1) below from the dot count integral value in the segment in the sub-scanning direction obtained from the controller (S6). Meanwhile, in the following Formula (1), “Idev(t)” represents normalized data of the developing current in each of the segments in the sub-scanning direction, “i(t)” represents a measured value of the developing current corresponding to each of the segments in the sub-scanning direction, “C(t)” represents a coefficient generated from the dot count integral value in each of the segments in the sub-scanning direction, and represents “K” a conversion coefficient to convert the developing current value to a toner adhesion amount.

f(t)=Idev(t)×K (1)

Here, note that Idev(t)=i(t)×C(t).

The coefficient C(t) is used to perform normalization excluding a difference of the toner adhesion amount between the respective segments in the sub-scanning direction, which may be varied by content of the image data, and the coefficient is calculated in real time from the dot count integral value obtained from the received image data. Generally, the smaller the dot count integral value is, the lower the measured value of the developing current is. Therefore, in the case where the dot count integral value is small, the coefficient C(t) is set large, and in the case where the dot count integral value is large, the coefficient C(t) is set small. The control section 37 sequentially calculates, from the received image data, the coefficient C(t) for each of the segments in the sub-scanning direction, and also can obtain the developing current normalized data Idev(t) in each of the segments in the sub-scanning direction by multiplying the calculated coefficient C(t) in each of the segments in the sub-scanning direction by the developing current data i(t) in each of the segments in the sub-scanning direction saved in the volatile memory.

After that, the control section 37 can obtain normalized image density for each of the segments in the sub-scanning direction by multiplying the conversion coefficient K by the calculated developing current normalized data Idev(t). Consequently, it is possible to obtain the image density unevenness profile f(t) in the sub-scanning direction, excluding the difference of the toner adhesion amount between the respective segments in the sub-scanning direction. Then, the control section 37 determines whether the obtained image density unevenness profile f(t) exceeds a predetermined allowable range (S7). In the case of exceeding the allowable range, the control section 37 controls the display unit 34 to inform that the image density unevenness is generated (S8). More specifically, for example, frequency analysis is performed for the obtained image density unevenness profile f(t), and in the case where there is any frequency component exceeding a predetermined threshold, it is determined that the image density unevenness exceeding the allowable range is generated. Subsequently, the above-described processing is repeatedly performed until there is no more received image data (S9).

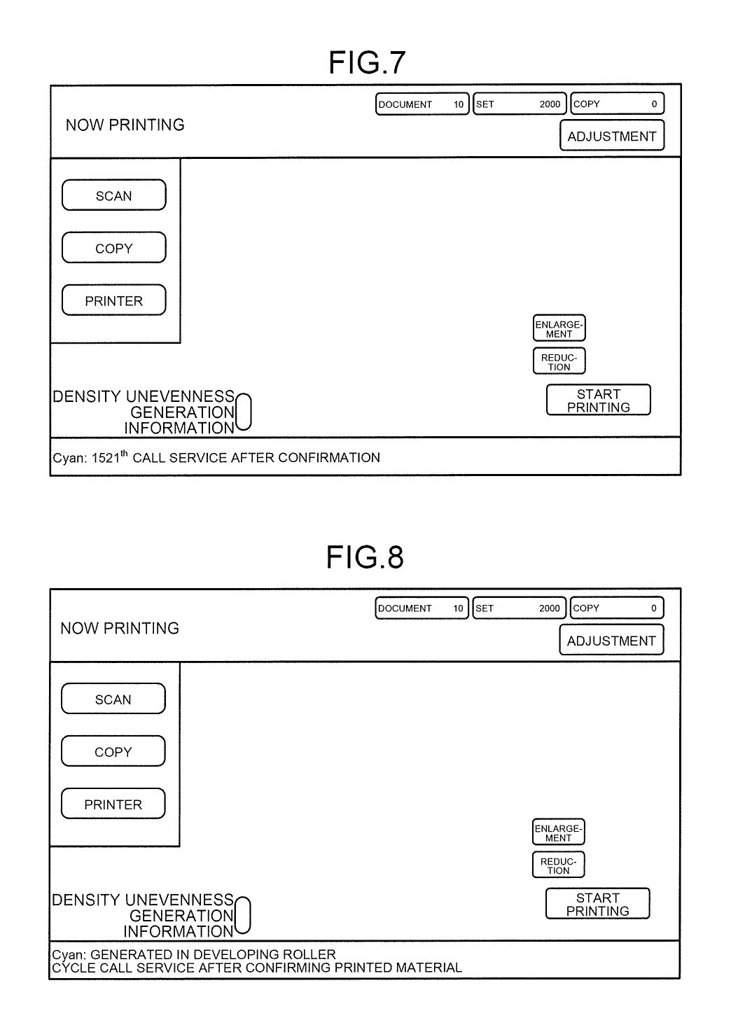

FIG. 7 is a diagram illustrating exemplary display content displayed on the display unit 34.

In the case where the control section 37 detects generation of the image density unevenness exceeding the allowable range, a character image of “density unevenness generation information” is displayed at a lower portion of the display unit 34 (operation panel). Furthermore, below this character image, a character image indicating in which color the image density unevenness is generated (“cyan” in FIG. 7) and a character image indicating what number of images the image density unevenness is generated (“1521th image” in FIG. 7), and the like are displayed.

Furthermore, in the first embodiment, not only generation of the image density unevenness is informed but also information indicating what kind of the image density unevenness is generated may also be informed, for example. More specifically, for example, frequency analysis is performed for the image density unevenness profile f(t), and a frequency component exceeding the predetermined threshold is extracted. Consequently, a main frequency (cycle) generating the image density unevenness can be specified. Therefore, it is possible to specify a causal component (photoconductor drum, developing roller, or the like) corresponding to the cycle of image density unevenness cycle. In this case, as illustrated in FIG. 8, a message indicating in what kind of cycle of image density unevenness is generated is displayed below the character image of “image density unevenness generation information” (“developing roller cycle” in FIG. 8).

Meanwhile, the informing method is not limited to the method of displaying an image such as a message on the display unit 34, and an informing method by a sound such as alarm or an informing method of transmitting an e-mail and the like to a user may also be applicable.

Furthermore, in the case of detecting generation of image density unevenness, other operation control may also be performed together with the above-described informing. For example, operation control may be performed such that image forming operation is continued until the number of generation times of image density unevenness reaches a prescribed value, but in the case where the number of generation times exceeds the prescribed value, it is determined that maintenance is required and image forming operation is to be interrupted. At this point, since visibility of image density unevenness is varied by the color in which the image density unevenness is generated or by a frequency difference of the image density unevenness. Therefore, the prescribed value may be set individually for each color or each frequency, and may have a configuration in which a user and an operator can change the setting.

### Second Embodiment

Next, another embodiment of an image forming device according to the present invention (hereinafter, the present embodiment will be referred to as “second embodiment”) will be described with reference to the drawings.

Meanwhile, since a configuration and operation in the second embodiment are basically the same as a first embodiment described above, a description will be provided below mainly for points different from the above-described first embodiment.

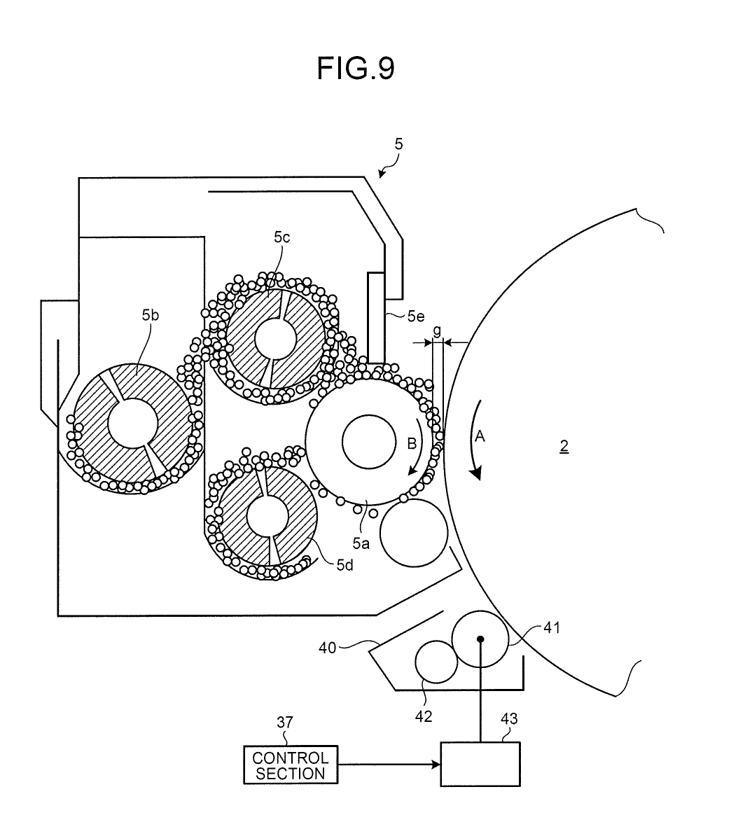

FIG. 9 is a schematic structural diagram illustrating a developing device and a toner amount adjustment device according to the second embodiment.

In the second embodiment, toner images developed on respective photoconductor drums 2Y, 2M, 2C, 2K have toner adhesion amounts adjusted by toner amount adjustment devices 40Y, 40M, 40C, 40K described later so as to reduce image density unevenness, and then are conveyed to a primary transfer nip portion as a primary transfer area that is a facing area between the photoconductor drums 2Y, 2M, 2C, 2K and an intermediate transfer belt 1.

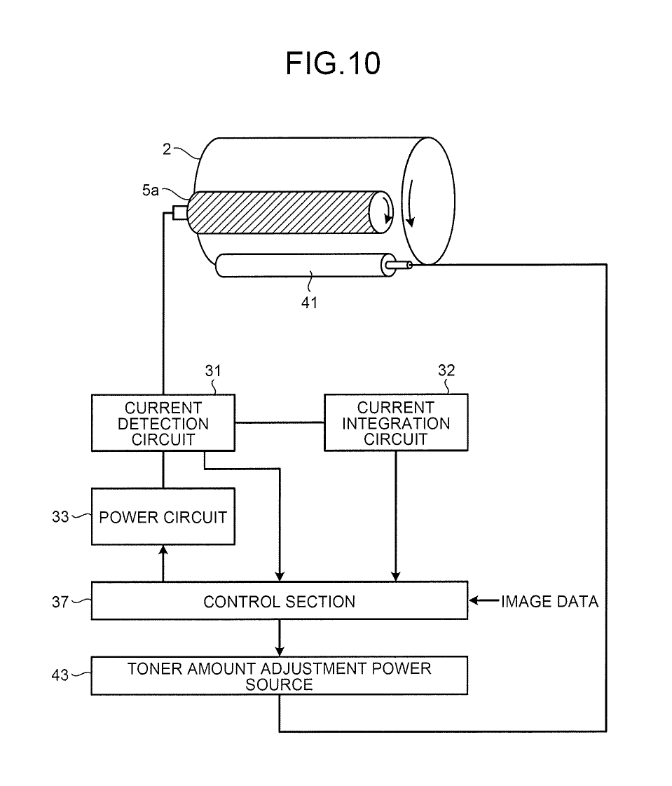

FIG. 10 is an explanatory diagram illustrating a main control system according to the second embodiment.

In the second embodiment also, provided is a developing current detection unit as a toner adhesion amount information detection unit that detects, as toner adhesion amount information, developing current flowing between the photoconductor drum 2 of each color and the developing roller 5a of the developing device 5. The developing current detection unit of the second embodiment also includes a current detection circuit 31 as illustrated in FIG. 10.

Here, as described above, in actual image forming operation, not only regular image density unevenness generated in every image forming but also irregular image density unevenness may be generated. The regular image density unevenness can be improved by correcting image formation conditions by feeding back detection results of surface potential sensors 19Y, 19C, 19M, 19K, a detection result of a toner adhesion amount detection sensor 30 at the time of image quality adjustment (process control), and the like. However, the irregular image density unevenness cannot be improved by thus correcting the image formation conditions.

Therefore, in the second embodiment, a control section 37 detects whether any image density unevenness is generated in each image actually formed by image forming, and image density unevenness correction to reduce the image density unevenness in the detected image is performed. More specifically, the control section 37 detects the image density unevenness generated in the image in accordance with developing current received in the control section 37 during developing processing for the image, and the image density unevenness correction is performed by using a toner amount adjustment device 40 so as to reduce the image density unevenness generated in the image.

Meanwhile, in the second embodiment, image density unevenness is detected based on a detection result of the developing current, but not limited thereto, and as far as a result is obtained by detecting toner adhesion amount information indicating a toner adhesion amount of a toner image formed based on image data, detection results of the surface potential sensors 19Y, 19C, 19M, 19K and a detection result of the toner adhesion amount detection sensor 30 can be also utilized.

However, content of the image actually formed is varied in accordance with the image data, and an entire image is not formed with constant image density like a toner pattern. Therefore, image density unevenness in a sub-scanning direction of the image cannot be directly grasped even though checking time variation of the developing current flowing while developing processing is performed for the actual image. On the other hand, the content of the image actually formed can be grasped from image data of this image, and a target value of image density variation (toner adhesion amount variation) in the sub-scanning direction of the image can be grasped from the image data. Therefore, in the second embodiment, a deviation amount between a target toner adhesion amount and an actual toner adhesion amount of the image is grasped from the developing current detected at the time of developing processing in the actual image and the image data of the image, and whether any image density unevenness is generated in the image is detected by checking variation of the deviation amount.

The image data received in the control section 37 is useful image information in order to grasp the target value of the toner adhesion amount of the toner image formed based on the image information such as information related to a formed image such as a printing rate in a main-scanning direction and image density, and writing information. In the second embodiment, the image data is divided into a plurality of segments in the sub-scanning direction, and the printing rate (area ratio of toner image portion) in each of the segments in the sub-scanning direction is grasped by using an integral value of a dot count value in the main-scanning direction in each of the segments (segments in the sub-scanning direction). Furthermore, information to grasp a relation between the detected developing current and a position on the image is also received in the control section 37. As an example of such information, information of writing start timing may be listed. Meanwhile, as far as the relation between the detected developing current and the position on the image can be grasped from the information, information at rising time of the detected developing current can also be used, not limited to the writing start timing.

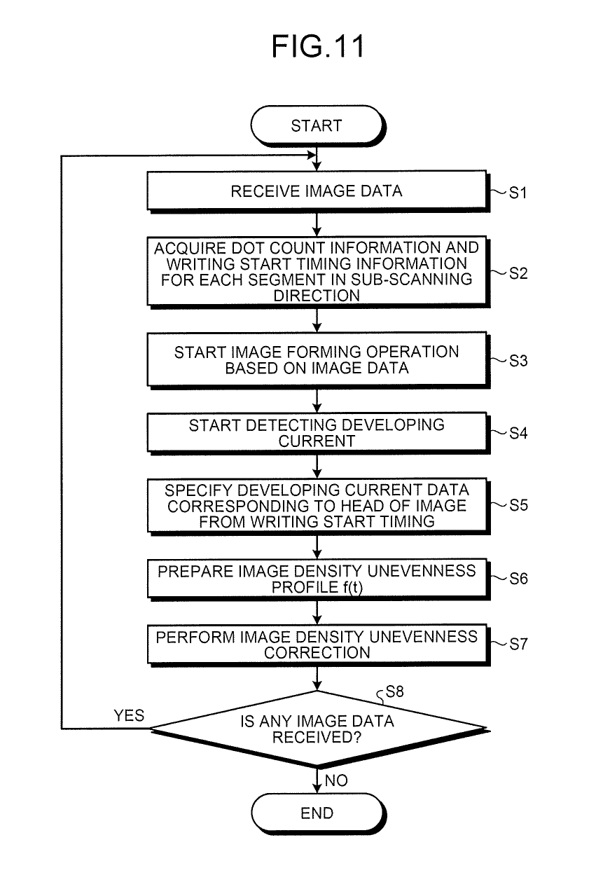

FIG. 11 is a flowchart illustrating a flow of controlling detection of image density unevenness according to the second embodiment.

Note that exemplary image data to be received is illustrated in FIGS. 5A to 5C same as the above-described first embodiment.

In the case where the image data of a picture image as illustrated in FIG. 5A is received (S1), a controller not illustrated inside an image forming device 100 converts the received image data to a printer language, and writing information such as a dot count and writing start timing is obtained. The controller transmits the information of the writing start timing to the control section 37 together with the dot count information. The control section 37 acquires the image density information and a dot count value for each predetermined segment in the sub-scanning direction from the dot count information received from the controller (S2), and saves the same in a volatile memory.

When image forming operation is started based on the received image data (S3), developing voltage is applied to the developing roller 5a from a power circuit 33 for developing, and at the same time, the control section 37 sequentially saves the developing current detected by the current detection circuit 31 in the volatile memory (S4). Furthermore, at the above-described writing start timing, forming an electrostatic latent image is started based on the image data, and the formed electrostatic latent image passes a developing area with rotation of the photoconductor drum 2. The toner is supplied from above the developing roller 5a to the electrostatic latent image passing the developing area, and adheres to the image, and then the image is developed.

The control section 37 specifies developing current data corresponding to a head of the image from among the developing current data saved in the volatile memory based on the writing start timing obtained from the controller (S5). Consequently, the value of each developing current corresponding to a position in the sub-scanning direction of the image data, namely, the developing current value in each of the above-described segments in the sub-scanning direction can be specified.

Next, same as the above-described first embodiment, the control section 37 calculates an image density unevenness profile f(t) of the image by above-described Formula (1) from the dot count integral value in the segment in the sub-scanning direction obtained from the controller (S6).

After that, the control section 37 can obtain normalized image density for each of the segments in the sub-scanning direction by multiplying a conversion coefficient K by a calculated developing current normalized data Idev(t). Consequently, it is possible to obtain the image density unevenness profile f(t) in the sub-scanning direction, excluding a difference of the toner adhesion amount between the respective segments in the sub-scanning direction. Then, the control section 37 performs image density unevenness correction described later based on the obtained image density unevenness profile f(t) (S7). After that, the above-described processing is repeatedly performed until there is no more received image data (S8).

Next, the image density unevenness correction in the second embodiment will be described.

The toner amount adjustment device 40 used in the image density unevenness correction of the second embodiment includes, as illustrated in FIG. 9: a toner amount adjustment roller 41 which is a rotating body arranged in a manner facing a surface of the photoconductor drum 2; a cleaning brush 42 as a cleaning member in order to clean toner adhering to an outer peripheral surface of the toner amount adjustment roller 41; and a toner amount adjustment power source 43 adapted to apply voltage to the toner amount adjustment roller 41 in accordance with control of the control section 37.

The toner amount adjustment device 40 can move toner on a toner image that passes the facing area to the toner amount adjustment roller 41 side by action of electric field generated in the facing area between the outer peripheral surface of the toner amount adjustment roller 41 applied with voltage and the toner image on the photoconductor drum 2 (hereinafter referred to as “toner amount adjustment area”). Therefore, the control section 37 controls the voltage applied to the toner amount adjustment roller 41, thereby enabling adjustment of the toner adhesion amount in each portion of the toner image that passes the toner amount adjustment area.

An axial length of the toner amount adjustment roller 41 is the same as the developing roller 5a, and preferably, is longer than a length in a main-scanning direction of a toner image formed on the photoconductor drum 2. A position in the rotational direction of the photoconductor drum, where the toner amount adjustment roller 41 is arranged, is set between the developing area and the primary transfer nip portion. In the second embodiment, since the image density unevenness is detected from the developing current as described above, the image density unevenness cannot be detected only after the toner image passes the developing area. Therefore, the toner amount adjustment roller 41 is arranged more on a downstream side of a toner image moving route than the developing area. On the other hand, in the second embodiment, the image density unevenness correction is performed for the toner image on the photoconductor drum 2. Therefore, the toner amount adjustment roller 41 is arranged more on an upstream side of the toner image moving route (rotational direction of the photoconductor drum) than the primary transfer nip portion. However, the image density unevenness correction can be performed not for the toner image on the photoconductor drum 2 but for a toner image on the intermediate transfer belt 1 or a toner image on a recording paper. In this case, the toner amount adjustment roller 41 is arranged more on the downstream side of the toner image moving route than the primary transfer nip portion.

In the image density unevenness correction processing of the second embodiment, first a correction coefficient that is correlation information indicating correlation between the image density unevenness profile f(t) and a correction value is preliminarily stored in a non-volatile memory inside the control section 37. The correction value corresponds to a voltage value applied to the toner amount adjustment roller 41 from the toner amount adjustment power source 43. Then, image forming operation is started based on received image data as described above, and when detection of the image density unevenness profile f(t) is started for the image, the correction value Vcr(t) is sequentially calculated by multiplying the correction coefficient P by the image density unevenness profile f(t) sequentially detected.

The correlation between the image density unevenness profile f(t) and the correction value Vcr(t) is varied with time in accordance with a state (developing capacity and the like) of the present image forming device. Therefore, a preferably configuration is to change the correction coefficient P in accordance with the state of the image forming device without using a fixed value as the correction coefficient P. For example, a data table indicating the correlation between the state of the image forming device and the correction coefficient P is preliminarily prepared, and an appropriate correction coefficient P is selected from the data table in accordance with a detection result of the state of the image forming device.

The control section 37 controls the toner amount adjustment power source 43 such that voltage according to the correction value Vcr(t) calculated from the image density unevenness profile f(t) is applied to the toner amount adjustment roller 41 at synchronized timing when a corresponding toner image passes the toner amount adjustment area. The timing can be calculated from, for example, layout information and a process speed (surface moving speed of the photoconductor drum 2) of the present image forming device.

In the second embodiment, since the voltage according to the correction value Vcr(t) calculated from the image density unevenness profile f(t) is applied to the toner amount adjustment roller 41. Therefore, when a toner image portion having a toner adhesion amount more than a target toner adhesion amount passes the toner amount adjustment area, excessive toner moves to the toner amount adjustment roller 41 side and adheres onto the outer peripheral surface of the toner amount adjustment roller 41. Consequently, the toner image portion can have the toner adhesion amount close to the target toner adhesion amount. As a result, image density unevenness in the sub-scanning direction generated in the image can be reduced. The toner adhering onto the outer peripheral surface of the toner amount adjustment roller 41 is electrostatically collected from the toner amount adjustment roller 41 by the cleaning brush 42. Meanwhile, as the cleaning member to clean the toner amount adjustment roller 41, other members besides the cleaning blade can be used as well.

Additionally, the image density unevenness correction of the second embodiment is adapted to reduce the image density unevenness by removing excessive toner from the toner image portion having a toner adhesion amount more than the target toner adhesion amount and reduce the toner adhesion amount, but the image density unevenness correction is not limited thereto. For example, the image density unevenness may be reduced by applying a deficient amount of toner to a toner image portion having a toner adhesion amount less than the target toner adhesion amount and increasing the toner adhesion amount. Alternatively, the image density unevenness may be reduced by increasing or decreasing the toner adhesion amount in accordance with excess or deficiency of the toner adhesion amount. For example, in the case of providing a configuration in which a toner layer of a predetermined amount is formed on the outer peripheral surface of the toner amount adjustment roller 41, the control section 37 controls the voltage applied to the toner amount adjustment roller 41 to control electric field generated in the toner amount adjustment area, and a toner adhesion amount in each portion of a toner image that passes the toner amount adjustment area can be increased or decreased.

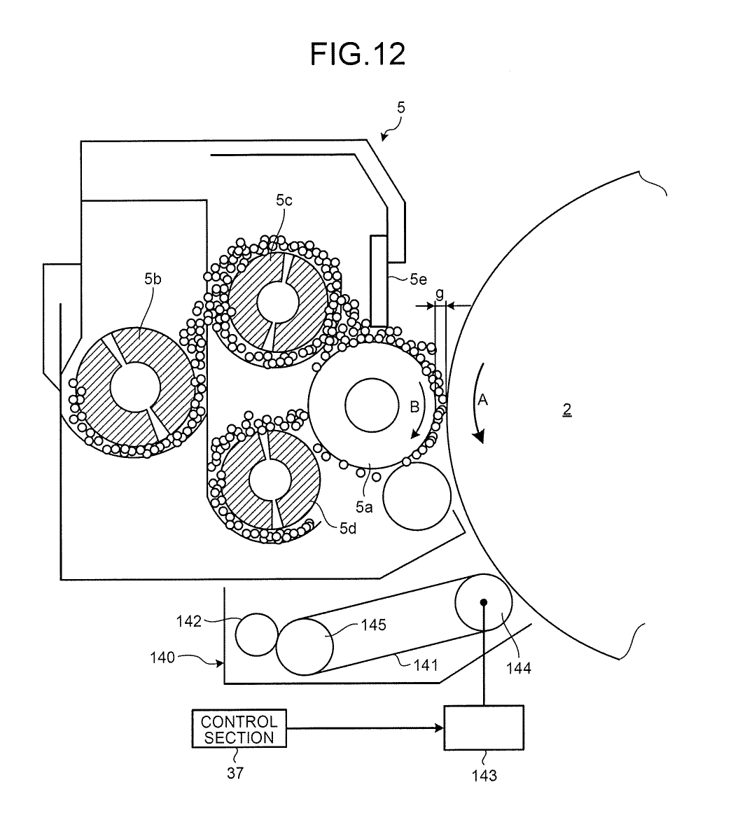

Furthermore, the toner amount adjustment device 40 of the second embodiment has the rotating body applied with the voltage in accordance with the correction value, such as the toner amount adjustment roller 41 that is a roller-like member, but the rotating body may also be a belt type member. For example, a toner amount adjustment device 140 illustrated in FIG. 12 can be applied. The toner amount adjustment device 140 has a configuration in which a toner amount adjustment belt 141 that is an endless belt member is stretched by two support rollers 144, 145, and voltage is applied from a toner amount adjustment power source 143 to one of the support rollers 144 arranged in a manner facing the photoconductor drum 2. Toner adhering onto the toner amount adjustment belt 141 is electrostatically collected by a cleaning brush 142.

### First Modified Example

Next, a modified example of controlling detection of image density unevenness in the above-described first and second embodiments will be described (hereinafter, the present modified example will be referred to as “first modified example”).

Even in the case of having the same total area of an electrostatic latent image existing in the developing area, it is confirmed that a detected developing current value is different depending on a distribution state of the electrostatic latent image. For example, comparing a case where the same number of dot latent images is arranged all adjacent to each other with a case where the same number of latent images is arranged apart from each other, the detected developing current value in the latter case is smaller than that in the former case. The reason is that in the case where the dot latent images are arranged apart from each other, potential in each of the dot latent images is dropped only by individual exposure, but in the case where the dot latent images are arranged adjacent to each other, exposure of the adjacent latent images influence each other and the potential in each of the dot latent images is more largely dropped.

Therefore, in the first modified example, not only a dot count integral value but also density information related to density of a dot latent image are used in calculating the coefficient C(t) in order to perform normalization excluding a difference of the toner adhesion amount between respective segments in the sub-scanning direction which may be varied by content of the image data. More specifically, the larger the dot count integral value is and the smaller the density of the dot latent image is, the smaller the coefficient C(t) is set. The smaller the dot count integral value is and the larger the density of the dot latent image is, the larger the coefficient C(t) is set. More specifically, the coefficient is calculated by Formula (2) below.

C(t)=∫(K1×D)·dt+∫(K2×A)·dt (2)

Note that in the Formula (2), “D” represents the density of the dot latent image, “A” represents a dot count integral value, “K1” represents a weighting factor for the dot latent image density D, and “K2” represents a weighting factor for the dot count integral value A. The weighting factor K1 is the factor preliminarily designed based on a test and varied by the dot latent image density D, and the weighting factor K2 is the factor preliminarily designed based on a test and varied by the dot count integral value A. Here, t represents time, and C(t) is sequentially calculated one in accordance with a predetermined control cycle.

Meanwhile, in the present modified example, assumed is a case where a single pattern of the latent image density D inside main scanning is formed, however; in the case where a plurality of latent image density patterns exists in the main-scanning direction, a first term in Formula (2) becomes as shown in Formula (3) below considering a main scanning length of the pattern in each main scanning position.

C(t)=∫(K1×D×L)·dt+∫(K2×A)·dt (3)

Here, “L” is the main scanning length. (K1×D×L) of the first term is calculated for each pattern and then added. With this configuration, even when a dot count value (second term) is the same, the first term is varied in accordance with pattern density (the value of the first term becomes large at high density, and becomes small at low density). Therefore, density unevenness information can be detected with higher accuracy than the above-described embodiments.

### Second Modified Example

Next, another modified example of controlling detection of image density unevenness in the above-described first and second embodiments will be described (hereinafter, the present modified example will be referred to as “second modified example”).

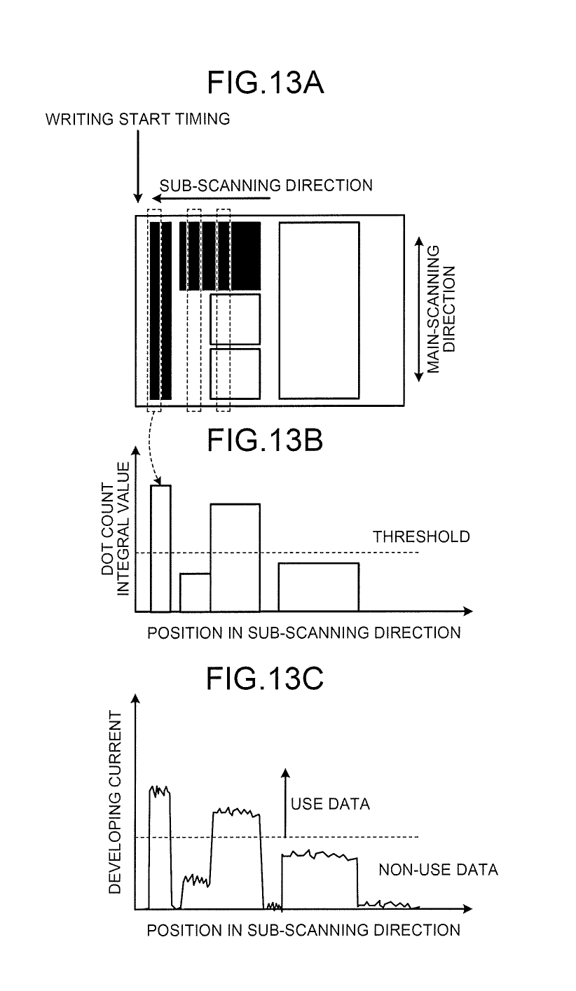

FIG. 13A is a diagram schematically illustrating a picture image of exemplary received image data.

FIG. 13A is a graph illustrating a dot count integral value in each segment in the sub-scanning direction of the image illustrated in FIG. 13A.

FIG. 13C is a graph illustrating time variation of detected developing current relative to the image illustrated in FIG. 13A (developing current value in each position in the sub-scanning direction).

In the second modified example, a dot count integral value obtained for each segment in the sub-scanning direction is compared with a threshold, and developing current data relative to the segment in the sub-scanning direction having the dot count integral value smaller than the threshold is not used to detect the image density unevenness. Consequently, the developing current data to be used to detect the image density unevenness can be limited to the one at the time of developing an image to which a toner adhesion amount of a predetermined value or more adheres. A measured value of the developing current detected at the time of developing an image having a small toner adhesion amount is a small value, and there may be a case where an error between the measured value and the toner adhesion amount is large due to influence of disturbance noise and the like. According to the second modified example, the image density unevenness is detected excluding such unreliable developing current data. Therefore, the image density unevenness can be detected with higher accuracy.

The threshold of the dot count integral value can be preliminarily set based on a test. In the first and second embodiments, the threshold is set such that a ratio of the dot count integral value against total number of dots in the segment in sub-scanning direction becomes 10%, but this threshold is suitably set.

Meanwhile, in the second modified example, the developing current data to be used to detect the image density unevenness is selected by comparing the dot count integral value with the threshold. Alternatively, the developing current data to be used to detect the image density unevenness may also be selected by comparing a developing current value with a threshold.

### Third Modified Example

Next, still another modified example of controlling detection of image density unevenness in the above-described first and second embodiments will be described (hereinafter, the present modified example will be referred to as “third modified example”).

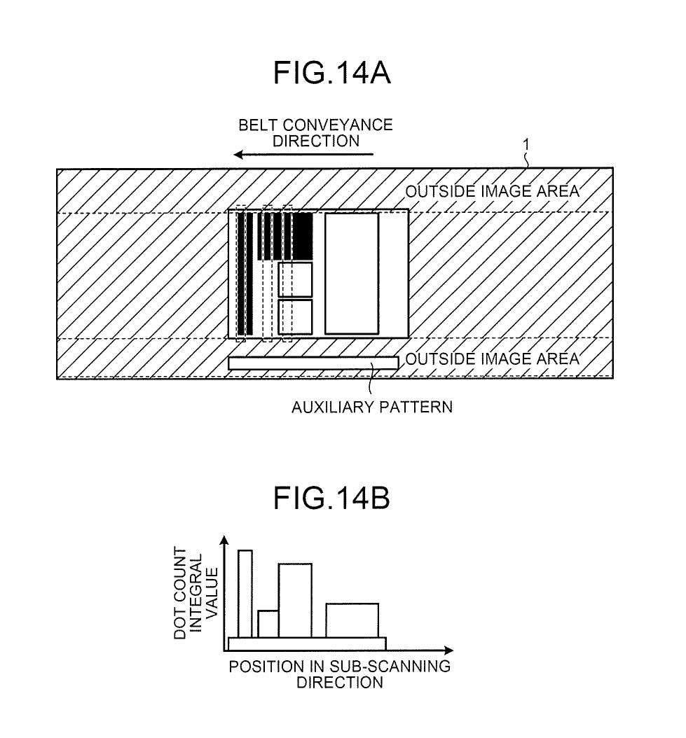

FIG. 14A is a diagram schematically illustrating a picture image on the surface of the intermediate transfer belt 1 relative to exemplary received image data.

FIG. 14B is a graph illustrating a dot count integral value in each segment in the sub-scanning direction of the image illustrated in FIG. 14A.

As described above, in the case where a measured value of the developing current is small, correlation between the developing current and the toner adhesion amount is hardly grasped due to disturbance noise and the like, and an error may become large. In the third modified example, as illustrated in FIG. 14A, an electrostatic latent image corresponding to a predetermined auxiliary toner pattern is formed outside an image area adjacent in the main-scanning direction thereof for an electrostatic latent image formed based on image data. In this case, as illustrated in FIG. 14B, an amount corresponding to dot count of the auxiliary toner pattern is added to a dot count integral value in each segment in the sub-scanning direction. Developing processing is performed for these electrostatic latent images at the same time. As a result, at least the developing processing for the predetermined auxiliary toner pattern is performed, and a lowest value of the developing current flowing at the time of developing processing can be raised.

Since a space to form the auxiliary toner pattern outside the image area is limited, the auxiliary toner pattern is preferably a high-density toner pattern having the toner adhesion amount of a predetermined amount or more. To raise the lowest value of the developing current, the toner pattern is preferably a solid pattern, but in the image forming device 100 of the first embodiment, a sufficient effect can be obtained when the toner pattern has the image density of 20% or more.

The auxiliary toner pattern may be formed for all of images, however; in order to suppress a toner consumption amount, the auxiliary toner pattern may be formed for a designated number of images after generation of image density unevenness is detected predetermined times or more, for example.

Additionally, the auxiliary toner pattern may also be formed only limited to the outside of an image area in the main-scanning direction of a segment in the sub-scanning direction by preliminarily specifying the segment in the sub-scanning direction in which a dot count integral value obtained from the controller is smaller than a predetermined threshold.

According to an embodiment, there is an effect that whether any irregular image density unevenness is generated in a formed image can be detected.

While the embodiments of the present invention have been described above, the present invention is not limited to the specific embodiments, and unless otherwise particularly limited in the above description, various kinds of modifications and changes can be made within the scope of the gist of the present invention recited in claims.

For example, the image forming device applying the present invention may be a color digital multifunction peripheral which is a multifunction peripheral of a copy machine, a printer, and a facsimile machine and capable of performing full-color image forming, otherwise, a single unit of a copy machine, a facsimile machine, a plotter, or a multifunction peripheral combining a copy machine with a printer, or maybe a multifunction peripheral combining others, and the like. In recent years, there are many image forming devices capable of forming color images, such as a color copying machine and a color printer, but the image forming device applying the present invention may be a device that can form only a monochrome image. In this kind of image forming device, preferably, image forming can be performed not only on a regular paper used for general copying and the like but also on any one of thick papers such as an OHP sheet, a card, a postcard, and an envelope as a sheet-like recording material that is a recording paper. This kind of image forming device may also be the image forming device capable of forming an image on one side of a recording paper as the recording material. The developer to be used in this kind of image forming device is not limited to two-component developer and may also be one-component developer.

The effects recited in the embodiments of the present invention are merely examples of the most optimal effects obtained from the present invention, and the effects of the present invention are not limited to those recited in the embodiments of the present invention.

The matters described above are examples, and the present invention provides specific effects in each of following aspects.

Aspect A

An image forming device 100 forms a toner image based on image information (image data) by using a toner image forming unit such as the charging devices 3Y, 3C, 3M, 3K, the optical writing unit 4, and the developing devices 5Y, 5C, 5M, 5K on the surface of a latent image bearer like the photoconductor drums 2Y, 2M, 2C, 2K whose surfaces move, and finally transfers the formed toner image to a recording material such as a recording paper, so as to form an image on the recording material. The image forming device 100 includes a toner adhesion amount information detection unit such as a current detection circuit 31, and an image density unevenness detection unit such as the control section 37. The toner adhesion amount information detection unit detects toner adhesion amount information like developing current i(t) indicating a toner adhesion amount of the toner image formed based on the image information. The image density unevenness detection unit detects, based on the image information and the toner adhesion amount information detected by the toner adhesion amount information detection unit, image density unevenness in the image formed based the image information.

Since it is difficult to estimate in which image irregular image density unevenness in a page is generated, it is necessary to detect whether any image density unevenness is generated in an image actually formed. At this point, content of the image actually formed is a wide variety in accordance with the image information, and an entire image is not formed with constant image density like a toner pattern. Therefore, the image density unevenness in the image cannot be grasped from a detection result obtained only by detecting, with a known toner adhesion amount information detection unit, a toner adhesion amount in a sub-scanning direction (direction corresponding to a latent image bearer surface moving direction) of the actually formed image. On the other hand, the content of the image actually formed can be grasped from the image information of the image, and a target value of toner adhesion amount variation in the sub-scanning direction of the image can be grasped from the image information. Therefore, variation in the sub-scanning direction with respect to a deviation amount between a target toner adhesion amount and an actual toner adhesion amount relative to the image can be grasped from the image information of the image and the toner adhesion amount information of the actual image detected by the toner adhesion amount information detection unit. The variation in the sub-scanning direction with respect to the deviation amount is the information indicating the image density unevenness of the image in the sub-scanning direction. Therefore, according to the present aspect, the image density unevenness in the image actually formed can be detected.

Aspect B

In Aspect A, the toner image forming unit forms the latent image based on the image information on the surface of the latent image bearer, and performs the developing processing in which toner charged to a predetermined polarity by applying developing bias between the latent image bearer and a developer bearer like the developing roller 5a is moved from the developer bearer to the latent image, so as to form the toner image on the surface of the latent image bearer. The toner adhesion amount information detection unit is a developing current detection unit like the current detection circuit 31 that detects, as the toner adhesion amount information, developing current i(t) flowing between the developer bearer and the latent image bearer at the time of performing the developing processing for the latent image formed based on the image information.

As the toner adhesion amount information detection unit that detects the toner adhesion amount information, for example, the toner adhesion amount detection sensor 30 that optically detects the image density of the toner image after the developing processing can be exemplified. According to a method of detecting the developing current as in Aspect B, the toner adhesion amount information can be detected almost at the same time with the developing processing. Therefore, compared to a method of detecting the toner adhesion amount information from the image density of the toner image, more quick detection can be achieved.

Aspect C

In Aspect B, the image density unevenness detection unit obtains, from the image information, an index value such as the dot count integral value indicating a toner adhesion amount of a toner image portion (segment in the sub-scanning direction) existing between the developer bearer and the latent image bearer when the developing current detection unit detects the developing current, and detects the image density unevenness based on the image information and the developing current flowing in the toner image portion (segment in the sub-scanning direction) when the index value indicates a toner adhesion amount of a prescribed amount or more.

According to Aspect C, as described in the second modified example, erroneous detection of the image density unevenness due to influence of disturbance noise and the like can be reduced, excluding the developing current having a small detected value. Therefore, the image density unevenness can be detected with higher accuracy.

Aspect D

In Aspect C, the index value includes an area ratio of the toner image portion in a direction orthogonal to the latent image bearer surface moving direction (main-scanning direction).

Since such an index value can be easily obtained from the image information, the index value can be more easily obtained.

Aspect E

In Aspect C or D, the index value includes the image density of the toner image portion in the direction orthogonal to the latent image bearer surface moving direction (main-scanning direction).

Since such an index value can be easily obtained from the image information, the index value can be more easily obtained.

Aspect F

In any one of Aspects B to E, the toner image forming unit performs developing processing by forming a latent image corresponding to a predetermined auxiliary toner pattern outside an image area in a direction orthogonal to the latent image bearer surface moving direction in a latent image portion corresponding to the toner image portion existing between the developer bearer and the latent image bearer when the developing current detection unit detects the developing current. The developing current detection unit detects the developing current when the toner image portion and the auxiliary toner pattern exist between the developer bearer and the latent image bearer.

According Aspect F, as described in the third modified example, a lowest value of detected developing current can be raised and influence of disturbance noise and the like can be reduced, and the image density unevenness can be detected with higher accuracy.

Aspect G

In Aspect F, the toner image forming unit obtains, from the image information, the index value such as the dot count integral value indicating the toner adhesion amount of the toner image portion, and forms the latent image corresponding to the predetermined auxiliary toner pattern outside the image area in the direction orthogonal to the latent image bearer surface moving direction in the latent image portion corresponding to the toner image portion when the index value indicates the toner adhesion amount smaller than a predetermined threshold.

According to Aspect G, toner consumption for forming an unnecessary auxiliary toner pattern can be suppressed.

Aspect H

In Aspect F or G, the auxiliary toner pattern is a toner pattern having the toner adhesion amount of the predetermined amount or more.

According to Aspect H, even when a space to form the auxiliary toner pattern is limited, the lowest value of the detected developing current can be raised, influence of disturbance noise and the like can be effectively reduced, and the image density unevenness can be detected with higher accuracy.

Aspect I

In any one of Aspects B to H, the image density unevenness detection unit obtains the developing current detected by the developing current detection unit only for a predetermined detection period, and detects the image density unevenness based on the obtained developing current and the image information.

In the case of detecting image density unevenness having a relatively long cycle, the developing current is needed to be detected for an entire area in the sub-scanning direction of the image, but in the case of detecting image density unevenness having a relatively short cycle, the developing current is not needed to be detected for the entire area in the sub-scanning direction of the image when the area in the sub-scanning direction of the image exceeds the cycle. According to Aspect I, as for the image density unevenness having the relatively short cycle, the image density unevenness can be detected faster than the case of detecting the developing current for the entire area in the sub-scanning direction of the image.

Particularly, in the case of providing a changing unit to change the predetermined detection period, once image density unevenness having a predetermined cycle is detected, it is possible to perform processing to change a detection period corresponding to the predetermined cycle and quickly detect image density unevenness only for the cycle.

Aspect J

In any one of Aspects A to I, the image forming device further includes an informing unit such as the display unit 34 that informs, when the image density unevenness detection unit detects the image density unevenness, the image density unevenness is generated.

According to Aspect J, a user or an operator can be informed of generation of the image density unevenness, and work burden to confirm generation of the image density unevenness can be reduced.

Aspect K

In any one of Aspects A to J, the image density unevenness detection unit detects image density unevenness in the latent image bearer surface moving direction. The image forming device further includes a toner adhesion amount increasing/decreasing unit, such as toner amount adjustment devices 40Y, 40C, 40M, 40K, and a control unit such as the control section 37. The toner adhesion amount increasing/decreasing unit increases or decreases the toner adhesion amount of the toner image after being formed on the latent image bearer. The control unit controls the toner adhesion amount increasing/decreasing unit in accordance with the detection result of the image density unevenness detection unit so as to reduce the image density unevenness in the image formed based on the image information.

According to Aspect 9, the image density unevenness in the sub-scanning direction generated in an image actually formed is detected, and the toner adhesion amount of the toner image where the image density unevenness is detected is increased or decreased by the toner adhesion amount increasing/decreasing unit, thereby reducing the image density unevenness in the sub-scanning direction in the image. Accordingly, even in an image already having irregular image density unevenness the image density unevenness can be suppressed, and the image can be utilized without waste although it is difficult to estimate in which image the irregular image density unevenness is generated.

Aspect L

In Aspect K, the toner adhesion amount information detection unit detects the toner adhesion amount information for the toner image on the surface of the latent image bearer, and the toner adhesion amount increasing/decreasing unit increases or decreases the toner adhesion amount of the toner image on the surface of the latent image bearer.

According Aspect L, the image density unevenness on the surface of the latent image bearer can be reduced. Therefore, even in the case of forming an image by superimposing a plurality of toner images, the image density unevenness can be individually reduced in each of the toner images.

Aspect M

In Aspect K or L, the toner adhesion amount increasing/decreasing unit reduces the toner adhesion amount by removing the toner from the toner image.

According to Aspect M, the image density unevenness can be reduced by simple configuration and control.

Aspect N

In Aspect M, the toner adhesion amount increasing/decreasing unit rotates, at a position facing the toner image, a rotating body such as a toner amount adjustment roller 41 applied with voltage in accordance with control of the control unit, and moves the toner to the rotating body by action of an electric field between the rotating body and the toner image.

According to Aspect N, the simple toner adhesion amount increasing/decreasing unit can be implemented.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An image forming device that forms a toner image with a toner image forming unit based on image information on a surface of a latent image bearer whose surface moves, and finally transfers the formed toner image to a recording material so as to form an image on the recording material, the image forming device comprising:
a toner adhesion amount information detection unit configured to detect toner adhesion amount information indicating a toner adhesion amount of a toner image formed based on image information; and
an image density unevenness detection unit configured to detect, based on the image information and the toner adhesion amount information detected by the toner adhesion amount information detection unit, image density unevenness in an image formed based on the image information, wherein
the toner image forming unit forms a latent image based on the image information on the surface of the latent image bearer, and performs the developing processing in which toner charged to a predetermined polarity by applying developing bias between the latent image bearer and a developer bearer is moved from the developer bearer to the latent image, so as to form the toner image on the surface of the latent image bearer,
the toner adhesion amount information detection unit is a developing current detection unit configured to detect, as the toner adhesion amount information, developing current flowing between the developer bearer and the latent image bearer at a time of performing developing processing for the latent image formed based on image information, and
the image density unevenness detection unit obtains, from the image information, an index value indicating a toner adhesion amount of a toner image portion existing between the developer bearer and the latent image bearer when the developing current detection unit detects developing current, and detects the image density unevenness based on the image information and the developing current flowing in the toner image portion when the index value indicates a toner adhesion amount of a prescribed amount or more.

2. The image forming device according to claim 1, wherein the index value includes an area ratio of the toner image portion in a direction orthogonal to a latent image bearer surface moving direction.

3. The image forming device according to claim 1, wherein the index value includes image density of the toner image portion in a direction orthogonal to a latent image bearer surface moving direction.

4. The image forming device according to claim 1, wherein
the toner image forming unit performs developing processing by forming a latent image corresponding to a predetermined auxiliary toner pattern outside an image area in a direction orthogonal to a latent image bearer surface moving direction in a latent image portion corresponding to a toner image portion existing between the developer bearer and the latent image bearer when the developing current detection unit detects developing current, and
the developing current detection unit detects the developing current when the toner image portion and the auxiliary toner pattern exist between the developer bearer and the latent image bearer.

5. The image forming device according to claim 4, wherein the toner image forming unit obtains, from the image information, an index value indicating a toner adhesion amount of the toner image portion, and forms a latent image corresponding to the predetermined auxiliary toner pattern outside an image area in a direction orthogonal to a latent image bearer surface moving direction in a latent image portion corresponding to the toner image portion when the index value indicates a toner adhesion amount smaller than a predetermined threshold.

6. The image forming device according to claim 1, further comprising an informing unit configured to, when the image density unevenness detection unit detects image density unevenness, inform that the image density unevenness is generated.

7. The image forming device according to claim 1, wherein
the image density unevenness detection unit detects image density unevenness in a latent image bearer surface moving direction, and
the image forming device further comprises:
a toner adhesion amount increasing/decreasing unit configured to increase or decrease a toner adhesion amount of the toner image after being formed on the latent image bearer; and
a control unit configured to control the toner adhesion amount increasing/decreasing unit in accordance with a detection result of the image density unevenness detection unit so as to reduce image density unevenness in the latent image bearer surface moving direction in the image formed based on the image information.

8. The image forming device according to claim 7, wherein
the toner adhesion amount information detection unit detects toner adhesion amount information for the toner image on the surface of the latent image bearer, and
the toner adhesion amount increasing/decreasing unit increases or decreases the toner adhesion amount of the toner image on the surface of the latent image bearer.

9. The image forming device according to claim 7 wherein the toner adhesion amount increasing/decreasing unit reduces the toner adhesion amount by removing toner from the toner image.

10. The image forming device according to claim 9, wherein the toner adhesion amount increasing/decreasing unit rotates, at a position facing the toner image, a rotating body applied with voltage in accordance with control of the control unit, and moves toner to the rotating body by action of an electric field between the rotating body and the toner image.
